(19) United States
(12) Patent Application Publication
(10) Pub. No.: US 2014/0025755 A1
(43) Pub. Date: Jan. 23, 2014

(54) INFERRING EVENTS BASED ON MOB SOURCE VIDEO

(71) Applicant: Ronald Paul Hughes, Santa Cruz, CA (US)

(72) Inventor: Ronald Paul Hughes, Santa Cruz, CA (US)

(73) Assignee: Google Inc., Mountain View, CA (US)

(21) Appl. No.: 13/554,953

(22) Filed: Jul. 20, 2012

(51) Int. Cl. G06F 15/16

(52) U.S. Cl. 709/206

(57) ABSTRACT

Methods and systems are disclosed for inferring that an event of interest (e.g., a public gathering, a performance, an accident, etc.) has likely occurred. In particular, when there are at least a given number of video clips with similar timestamps and geolocation stamps uploaded to a repository, it is inferred that an event of interest has likely occurred, and a notification signal is transmitted (e.g., to a law enforcement agency, to a news organization, to a publisher of a periodical, to a public blog, etc.).

### TECHNICAL FIELD

Embodiments of the present invention relate to data processing, and more specifically, to processing of video clips or other types of data that are timestamped and geolocation-stamped of.

### BACKGROUND

Video is becoming pervasive on the World Wide Web. In addition to content providers (e.g., news organizations, media companies, etc.) providing a wealth of video clips on their websites, everyday users are uploading user-generated video clips to various repository websites. In addition, users of such websites may “follow” other users in the same way as users of social networking services and conveniently view video clips uploaded by or recommended by these other users. User-generated video clips are typically recorded with digital video cameras, digital still cameras that have video capability, and increasingly, wireless terminals (e.g., smartphones, etc.) that have still camera and video capabilities.

### SUMMARY

In an embodiment of the present invention, a computer system infers that an event of interest (e.g., a public gathering, a performance, an accident, etc.) has likely occurred when there are at least a given number of video clips with similar timestamps and geolocation stamps uploaded to a repository. The computer system, in response to the inference, transmits a notification (e.g., to a law enforcement agency, to a news organization, to a publisher of a periodical, to a public blog, etc.) that indicates the likely occurrence of an event, as well as a time and geolocation associated with the event.

### BRIEF DESCRIPTION OF THE DRAWINGS

Embodiments of the present invention will be understood more fully from the detailed description given below and from the accompanying drawings of various embodiments of the invention, which, however, should not be taken to limit the invention to the specific embodiments, but are for explanation and understanding only.

FIG. 1 illustrates an exemplary system architecture, in accordance with one embodiment of the present invention.

FIG. 2 is a block diagram of one embodiment of a video clip manager.

FIG. 3 depicts a flow diagram of one embodiment of a method for monitoring a video clip repository.

FIG. 4 depicts a flow diagram of one embodiment of a method for pre-processing existing video clips in a video clip repository.

FIG. 5 depicts a flow diagram of one embodiment of a method for processing a new video clip that is added to a video clip repository.

FIG. 6 depicts a block diagram of an illustrative computer system operating in accordance with embodiments of the invention.

### DETAILED DESCRIPTION

Embodiments of the present invention take advantage of the fact that wireless terminals (e.g., smartphones, etc.) may have geolocation capabilities such as Global Positioning System [GPS] receivers, location estimation via Wi-Fi hotspots, etc., and may assign timestamps and geolocation stamps to video clips recorded by the terminal. In particular, methods and systems are described for inferring that an event of interest (e.g., a public gathering, a performance, an accident, etc.) has likely occurred and transmitting a notification of the existence of the event to a particular recipient (e.g., to a law enforcement agency, to a news organization, to a publisher of a periodical, to a public blog, etc.). In an embodiment of the present invention, a computer system determines when there are at least a given number of video clips uploaded to a repository having similar timestamps and geolocation stamps, within suitable thresholds. For example, if 12 video clips having timestamps within 5 minutes of each other and geo-location stamps within 20 meters of each other have been uploaded to a repository, then the computer system might infer that an event of interest occurred at that time and geolocation and transmit a notification to a local television news channel.

In one embodiment, a computer system pre-processes existing video clips in a video clip repository by defining groups of “related” video clips, based on the timestamps and geolocation stamps of the video clips. When there is a group whose size (i.e., the number of video clips in the group) meets or exceeds a size threshold, the computer system transmits a notification to one or more recipients (e.g., a news organization, etc.) that an event of interest likely occurred at the indicated time and geolocation. In one such embodiment, the computer system also determines the particular recipient(s) of the notification based on the geolocation of the event (e.g., an event in Manhattan might be transmitted to NYC Police and Channel 7 New York, etc.), the time of the event (e.g., an event at 3:00 am might go to the police but not a television station), or other criteria (e.g., the number of video clips in the group, the times at which the video clips were uploaded to the repository, metadata tags applied to video clips, etc.)

In one embodiment, after the repository has been processed, the computer system monitors video clips that are newly-uploaded to the repository and, based on their timestamps and geolocation stamps, adds the newly-uploaded video clips to existing groups, or creates new groups. When a video clip is added to a group and the size of the group has reached, for the first time, the size threshold, the computer system transmits one or more notifications, as described above.

In one embodiment, an author of an uploaded video clip is asked for permission for the video clip to be considered in the inferring of events. Video clips are included in groups and counted only when the author has granted his or her permission.

Embodiments of the present invention are thus capable of providing near-real-time information to pertinent organizations when users of wireless terminals upload video clips to the repository upon being recorded. Moreover, while embodiments of the present invention are described with reference to video clips, embodiments of the present invention also apply to other types of content, such as still photographs, audio clips, and so forth.

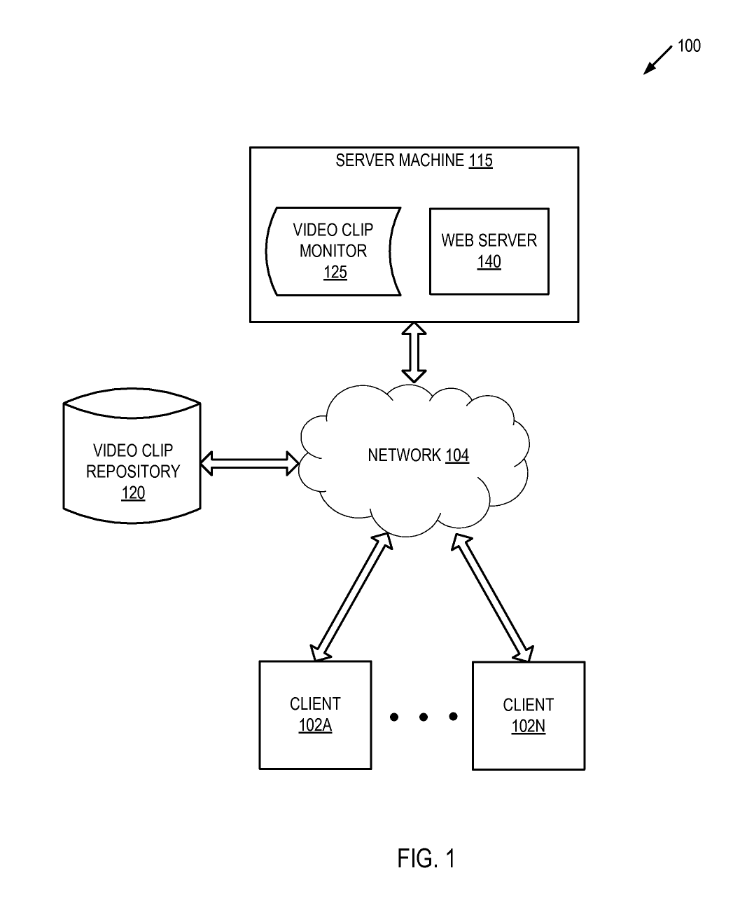

FIG. 1 illustrates an example system architecture 100, in accordance with one embodiment of the present invention. The system architecture 100 includes a server machine 115, a video clip repository 120 and client machines 102A-102N connected to a network 104. Network 104 may be a public network (e.g., the Internet), a private network (e.g., a local area network (LAN) or wide area network (WAN)), or a combination thereof.

The client machines 102A-102N may be wireless terminals (e.g., smartphones, etc.), personal computers (PC), laptops, tablet computers, or any other computing or communication devices. The client machines 102A-102N may run an operating system (OS) that manages hardware and software of the client machines 102A-102N. A browser (not shown) may run on the client machines (e.g., on the OS of the client machines). The browser may be a web browser that can access content served by a web server. The browser may issue image and/or video search queries to the web server or may browse images and/or videos that have previously been classified. The client machines 102A-102N may also upload images and/or video to the web server for storage and/or classification.

Server machine 115 may be a rackmount server, a router computer, a personal computer, a portable digital assistant, a mobile phone, a laptop computer, a tablet computer, a camera, a video camera, a netbook, a desktop computer, a media center, or any combination of the above. Server machine 115 includes a web server 140 and a video clip monitor 125. In alternative embodiments, the web server 140 and video clip monitor 125 may run on different machines.

Video clip repository 120 is a persistent storage that is capable of storing video clips and other types of content (e.g., images, audio clips, text-based documents, etc.) as well as data structures to tag, organize, and index the video clips and other types of content. In some embodiments video clip repository 120 might be a network-attached file server, while in other embodiments video clip repository 120 might be some other type of persistent storage such as an object-oriented database, a relational database, and so forth, that may be hosted by the server machine 115 or one or more different machines coupled to the server machine 115 via the network 104. The video clips stored in the video clip repository 120 may include user-generated content that is uploaded by client machines. The video clips may additionally or alternatively include content provided by service providers such as news organizations, publishers, libraries and so on.

Web server 140 may serve video clips from video clip repository 120 to clients 102A-102N. Web server 140 may receive search queries and perform searches on the video clips in the video clip repository 120 to determine video clips that satisfy the search query. Web server 140 may then stream to a client 102A-102N those video clips that match the search query.

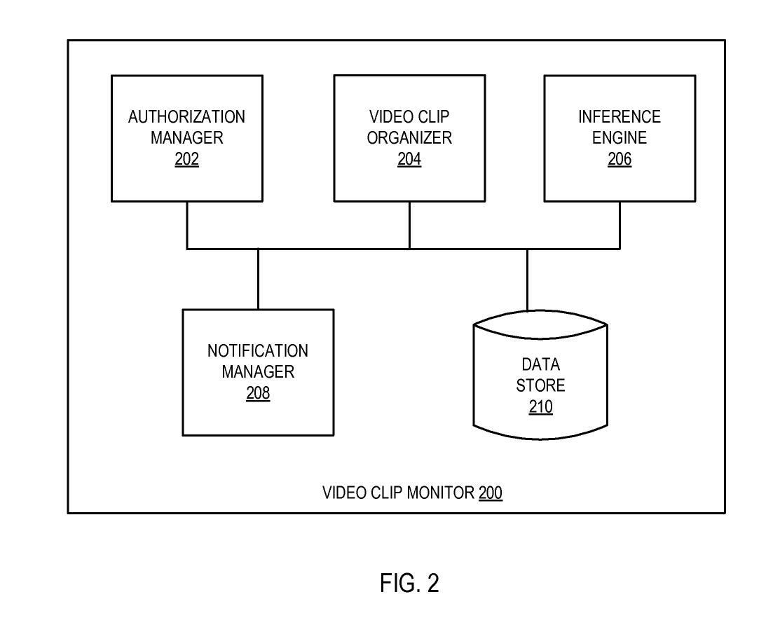

In accordance with some embodiments, video clip monitor 125 is capable of storing uploaded video clips in video clip repository 120, of indexing the video clips in video clip repository 120, of identifying groups of video clips in video clip repository 120 that are related, based on their timestamps and geolocation stamps, of requesting permission from users to include their video clips in such groups, of inferring the likely occurrence of events based on these groups, and of notifying one or more recipients of the likely occurrence of events based on these inferences, and provides users the opportunity to opt-out of having their timestamps and geolocation stamps collected and/or shared. An embodiment of video clip monitor 125 is described in detail below and with respect to FIG. 2.

FIG. 2 is a block diagram of one embodiment of a video clip monitor 200. The video clip monitor 200 may be the same as the video clip monitor 125 of FIG. 1 and may include an authorization manager 202, a video clip organizer 204, an inference engine 206, a notification manager 208, and a data store 210. The components can be combined together or separated in further components, according to a particular embodiment.

The data store 210 may be a temporary buffer or a permanent data store to hold one or more video clips that are to be stored in video clip repository 120, one or more video clips that are to be processed, one or more data structures for tagging and indexing video clips in video clip repository 120, messages for requesting permissions from users, responses to these requests from users, user permissions specified in the responses, messages for notifying recipients of the likely occurrence of events, or some combination of these data. Alternatively, data store 210 may be hosted by one or more storage devices, such as main memory, magnetic or optical storage based disks, tapes or hard drives, NAS, SAN, and so forth. In one embodiment, the video clip monitor 200 notifies users of the the. types of information that are stored in the data store 210, and provides the users the opportunity to opt-out of having such information collected and/or shared with the video clip r onitor 200.

The authorization manager 202 requests permission from users for their uploaded video clips to be included in groups and counted in the inferring of events; receives responses to these permission requests from users; stores the permissions that are specified in these responses in video clip repository 120; and ensures that video clip organizer 204, inference engine 206 and notification manager 208 comply with these permissions.

The video clip organizer 204 identifies groups of video clips in video clip repository 120 that are “related”—i.e., whose timestamps are within a time threshold of each other, and whose geolocation stamps are within a distance threshold of each other—and stores information about these groups in video clip repository 120 for rapid retrieval (e.g., as rows of a table in a relational database, as sets in an object-oriented database, etc.). In some embodiments, the time and distance thresholds may be established by a system administrator of server machine 115, while in some other embodiments such thresholds may be hard-coded into logic contained in video clip organizer 204, while in still some other embodiments these thresholds may be determined individually for each group by video clip organizer 204, based on criteria such as the geolocation associated with the group (e.g., a distance threshold in Manhattan might be smaller than a distance threshold in a small town), the time associated with the group, and so forth, as well as possibly dynamic criteria such as the number of video clips in the group, metadata tags applied to video clips, etc.

The inference engine 206 monitors the creation and augmentation of groups of video clips by video clip organizer and infers the likely occurrence of an event when a group reaches a given size threshold for the first time. In some embodiments, the size threshold may be established by a system administrator of server machine 115, while in some other embodiments the size threshold may be hard-coded into logic contained in inference engine 206, while in still some other embodiments the size threshold may be determined individually for each group by inference engine 206, based on criteria such as the time associated with a group of video clips (e.g., the size threshold might be lower at 1:00 am than 1:00 pm), the geolocation associated with a group of video clips (e.g., the size threshold might be higher in midtown Manhattan than in a small town), and so forth.

The notification manager 208 transmits messages to notify recipients (e.g., a law enforcement agency, a news organization, etc.) of the likely occurrence of events, and the time and geolocation of these events, in response to the processing of inference engine 206. In some embodiments, the recipients may be established by a system administrator of server machine 115, while in some other embodiments the recipients may be hard-coded into logic contained in notification manager 208, while in still some other embodiments the recipients may be determined individually for each group by notification manager 208, based on criteria such as the time associated with a group of video clips, the geolocation associated with a group of video clips, the number of video clips in a group, and so forth.

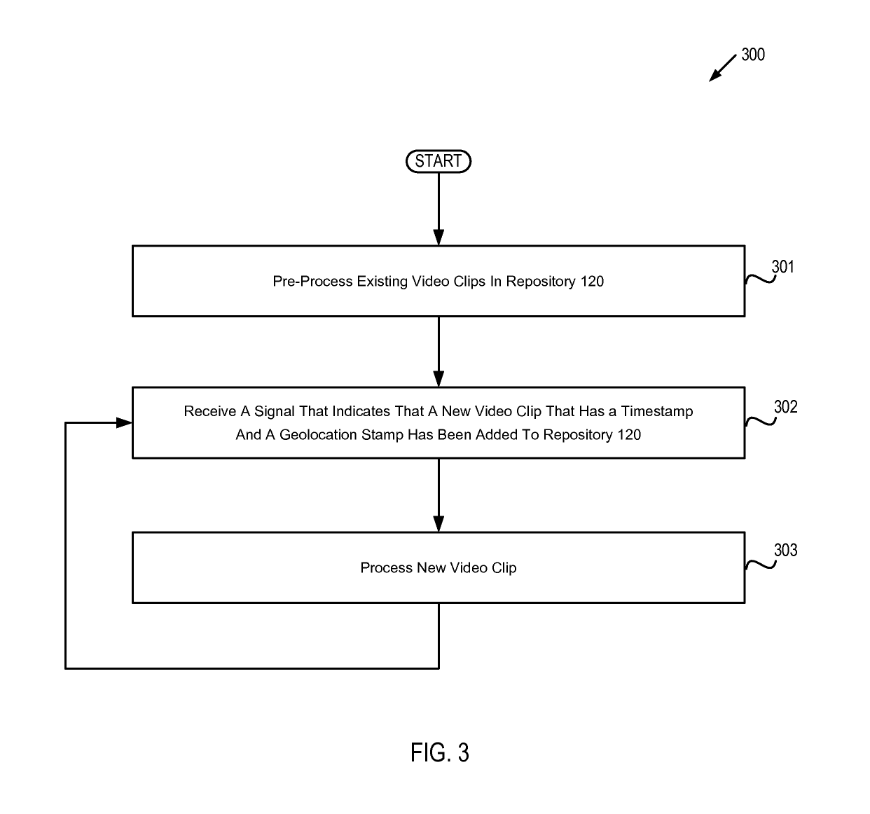

FIG. 3 depicts a flow diagram of one embodiment of a method 300 for monitoring video clips in video clip repository 120. The method is performed by processing logic that may comprise hardware (circuitry, dedicated logic, etc.), software (such as is run on a general purpose computer system or a dedicated machine), or a combination of both. In one embodiment, the method is performed by the server machine 115 of FIG. 1, while in some other embodiments, one or more of blocks 301 through 303 might be performed by another machine. It should be noted that in some embodiments, various components of video clip monitor 200 may run on separate machines.

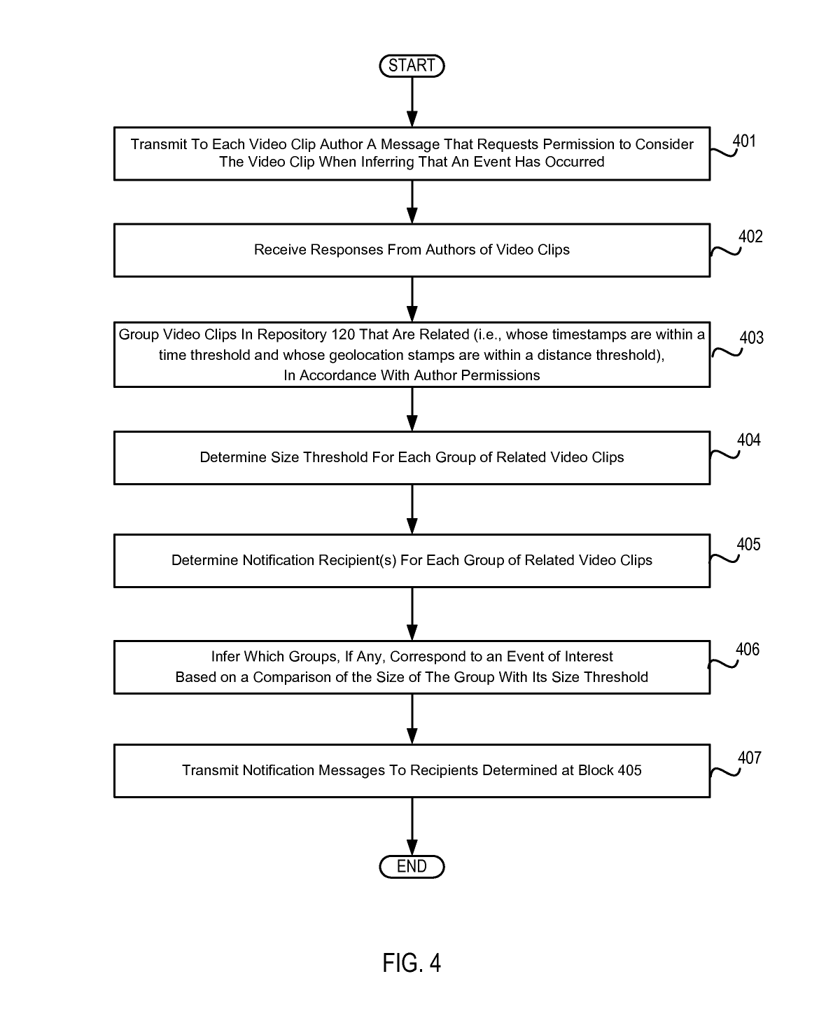

At block 301, existing video clips in repository 120 are pre-processed. An embodiment of video clip pre-processing is described in more detail below and with respect to FIG. 4. In accordance with one embodiment, block 301 is performed by video clip monitor 125.

At block 302, a signal is received that indicates that a new video clip having a timestamp and a geolocation stamp has been added to video clip repository 120. In accordance with one embodiment, the signal is generated by web server 140 and transmitted to video clip monitor 125.

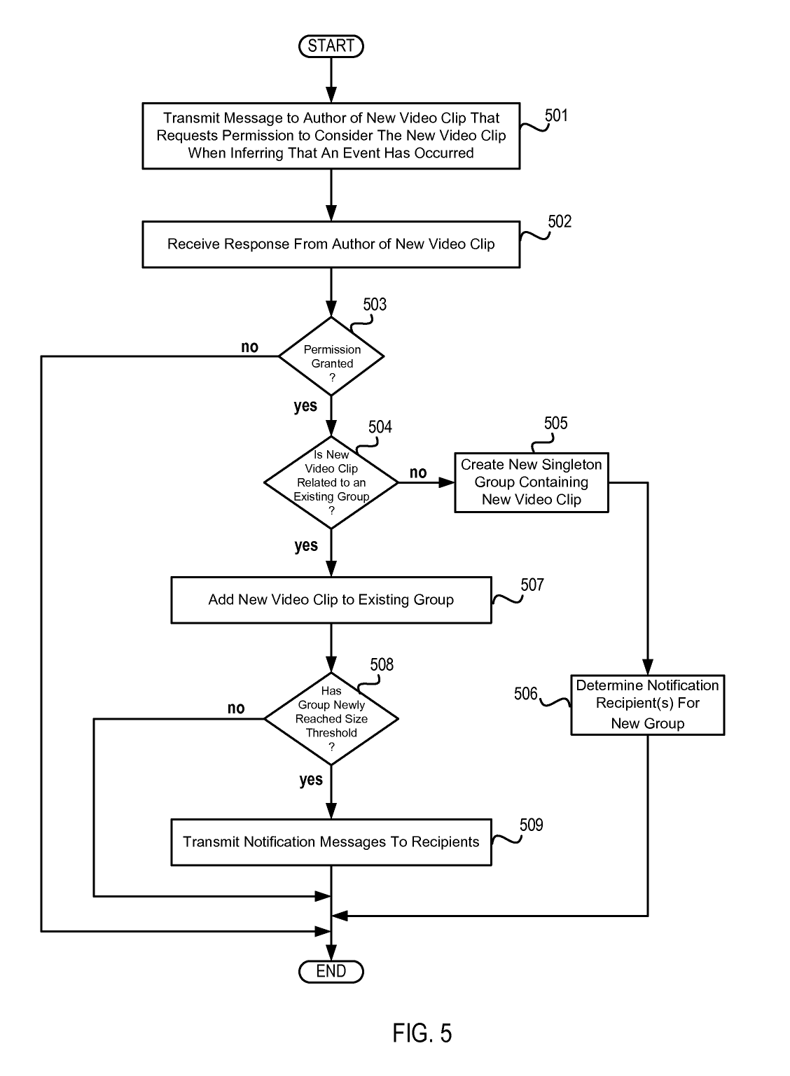

At block 303, the new video clip is processed. An embodiment of new video clip processing is described in more detail below and with respect to FIG. 5. In accordance with one embodiment, block 303 is performed by video clip monitor 125. After block 303, method 300 returns to block 302.

FIG. 4 depicts a flow diagram of one embodiment of a method for pre-processing existing video clips in video clip repository 120. At block 401, a message is transmitted to each author of a video clip in repository 120. The message requests permission from the author to include their video clip in a group and be counted when inferring the occurrence of events. In some embodiments, authors may be asked to explicitly provide permission for each uploaded video clip, while in some other embodiments, authors may be asked to provide a “blanket” consent or refusal for all of their uploaded video clips, past and future. In one embodiment, block 401 is performed by authorization manager 202 by sending the author an email with a link to a webpage for granting permissions or opting out of having such information collected and/or shared with the video clip monitor 200.

At block 402, responses are received from the authors. In one embodiment, authorization manager 202 receives the responses and stores the permissions in video clip repository 120.

At block 403, video clips in repository 120 that are related (i.e., whose timestamps are within a time threshold of each other and whose geolocation stamps are within a distance threshold of each other) are organized into groups, subject to author permissions. In accordance with one embodiment, block 403 is performed by video clip organizer 204, with author permissions enforced by authorization manager 202. As described above, in some embodiments, the time and distance thresholds may be established a priori by a system administrator of server machine 115, while in some other embodiments such thresholds may be hard-coded into logic contained in video clip organizer 204, while in still some other embodiments these thresholds may be determined individually for each group by video clip organizer 204, based on criteria such as the geolocation associated with the group, the time associated with the group, metadata tags applied to video clips, and so forth. It should be noted that a variety of techniques may be employed in block 403 to identify related video clips in repository 120, such as clustering, quantization and linear-time sorting, and so forth.

At block 404, size thresholds are determined for each group of related video clips. As described above, in some embodiments a uniform size threshold for all groups may be established a priori by a system administrator of server machine 115, or may be hard-coded into logic contained in inference engine 206, while in some other embodiments size thresholds may be determined individually for each group by inference engine 206, based on criteria such as the time associated with the group, the geolocation associated with the group, and so forth.

At block 405, one or more notification recipients (e.g., a law enforcement agency, a news organization, etc.) are determined for each group of related video clips. As described above, in some embodiments, the recipients may be established a priori by a system administrator of server machine 115, while in some other embodiments the recipients may be hard-coded into logic contained in notification manager 208, while in still some other embodiments the recipients may be determined individually for each group by notification manager 208, based on criteria such as the time associated with the group, the geolocation associated with the group, the number of video clips in a group, metadata, and so forth.

It should be noted that in some embodiments block 405 might be performed only for groups that have met or exceeded their size threshold, rather than for all groups. In such embodiments, block 405 might then be performed subsequently whenever a newly-uploaded video clip causes a group to reach its size threshold for the first time, as described in detail below with respect to the method of FIG. 5.

At block 406, the sizes of groups (i.e., the number of video clips in each group) are compared with their size thresholds to infer whether any of the groups likely correspond to an event of interest. In one embodiment, block 406 is performed by inference engine 206.

At block 407, messages are transmitted to recipients determined at block 405 for each group corresponding to an event of interest, as inferred at block 406. The messages indicate that an event of interest likely occurred at the time and geolocation associated with the corresponding group of video clips. In one embodiment, block 407 is performed by notification manager 208.

FIG. 5 depicts a flow diagram of one embodiment of a method for processing a new video clip that is added to a video clip repository. At block 501, a message is transmitted to the author of the new video clip requesting permission from the author to include their video clip in a group and be counted when inferring the occurrence of events. In one embodiment, block 501 is performed by authorization manager 202.

At block 502, a responses is received from the author of the new video clip. In one embodiment, authorization manager 202 receives the response and stores the corresponding permission/refusal in video clip repository 120. As described above, in some embodiments, the author of the new video clip may have previously provided a “blanket” consent or refusal for all future uploaded video clips, in which case block 501 and block 502 may be omitted from the method.

Block 503 branches based on whether the author granted permission to consider the new video clip. If the author did grant permission, execution proceeds to block 504, otherwise the method of FIG. 5 terminates. In one embodiment, block 503 is performed by authorization manager 202.

At block 504, the timestamp and geolocation stamp of the new video clip is used to determine whether the new video clip is related to an existing group in video clip repository 120. If the new video clip is related to an existing group, execution continues at block 507, otherwise execution continues at block 505. In one embodiment, block 504 is performed by video clip organizer 204.

At block 505, a new singleton group (i.e., a group with a single video clip) is created containing the new video clip. In one embodiment, block 505 is performed by video clip organizer 204.

At block 506, one or more notification recipients (e.g., a law enforcement agency, a news organization, etc.) are determined for the new singleton group. As described above, in some embodiments, the recipients may be established a priori by a system administrator of server machine 115, while in some other embodiments the recipients may be hard-coded into logic contained in notification manager 208, while in still some other embodiments the recipients may be determined for the new group based on criteria such as the timestamp of the new video clip, the geolocation of the new video clip, one or more metadata tags applied to the new video clip by the author, and so forth. In one embodiment, block 506 is performed by notification manager 208. After block 506, the method of FIG. 5 terminates.

At block 507, the new video clip is added to the existing group identified at block 504. In one embodiment, block 507 is performed by video clip organizer 204.

Block 508 determines whether the addition of the new video clip to the existing group results in the group reaching, for the first time, the size threshold for the group. If so, execution proceeds to block 509, otherwise the method of FIG. 5 terminates. In one embodiment, block 508 is performed by video clip organizer 204.

At block 509, messages that indicate the likely occurrence of an event of interest at the time and geolocation associated with the existing group are transmitted to appropriate recipients. As described above, in one embodiment, the recipients may have been determined at block 405, or at block 506 during a prior execution of FIG. 5 (i.e., for a previously-uploaded video clip), while in some other embodiments, the recipients might instead be determined at block 509 immediately prior to transmitting the notifications.

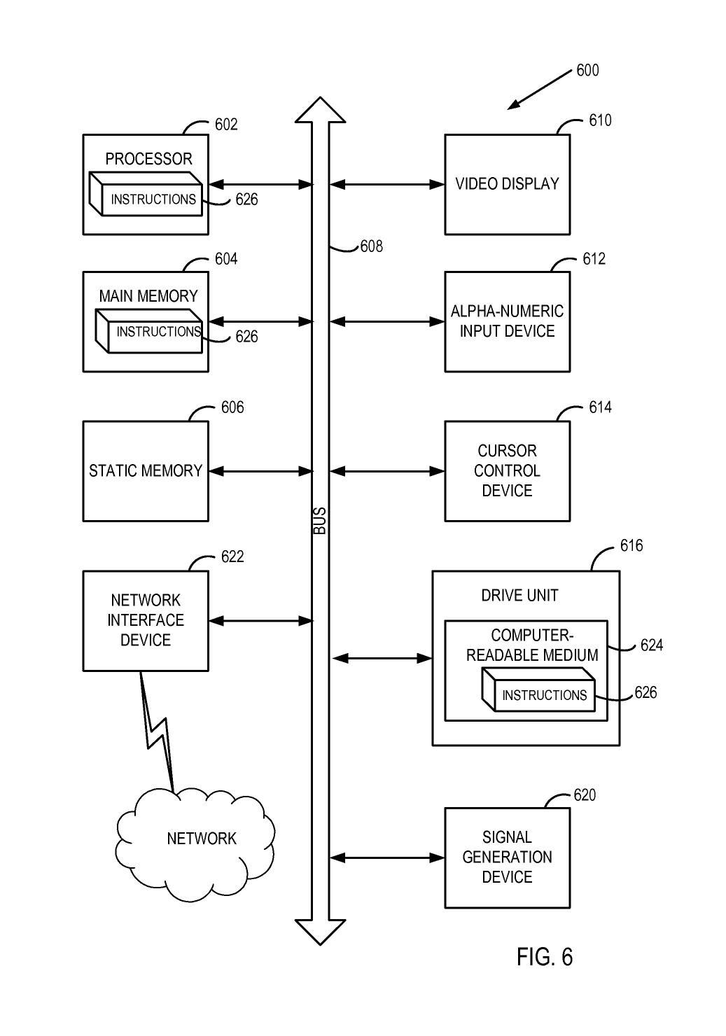

FIG. 6 illustrates an exemplary computer system within which a set of instructions, for causing the machine to perform any one or more of the methodologies discussed herein, may be executed. In alternative embodiments, the machine may be connected (e.g., networked) to other machines in a LAN, an intranet, an extranet, or the Internet. The machine may operate in the capacity of a server machine in client-server network environment. The machine may be a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 600 includes a processing system (processor) 602, a main memory 604 (e.g., read-only memory (ROM), flash memory, dynamic random access memory (DRAM) such as synchronous DRAM (SDRAM)), a static memory 606 (e.g., flash memory, static random access memory (SRAM)), and a data storage device 616, which communicate with each other via a bus 608.

Processor 602 represents one or more general-purpose processing devices such as a microprocessor, central processing unit, or the like. More particularly, the processor 602 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 602 may also be one or more special-purpose processing devices such as an application specific integrated circuit (ASIC), a field programmable gate array (FPGA), a digital signal processor (DSP), network processor, or the like. The processor 602 is configured to execute instructions 626 for performing the operations and steps discussed herein.

The computer system 600 may further include a network interface device 622. The computer system 600 also may include a video display unit 610 (e.g., a liquid crystal display (LCD) or a cathode ray tube (CRT)), an alphanumeric input device 612 (e.g., a keyboard), a cursor control device 614 (e.g., a mouse), and a signal generation device 620 (e.g., a speaker).

The data storage device 616 may include a computer-readable medium 624 on which is stored one or more sets of instructions 626 (e.g., instructions executed by video clip monitor 125, etc.) embodying any one or more of the methodologies or functions described herein. Instructions 626 may also reside, completely or at least partially, within the main memory 604 and/or within the processor 602 during execution thereof by the computer system 600, the main memory 604 and the processor 602 also constituting computer-readable media. Instructions 626 may further be transmitted or received over a network via the network interface device 622.

While the computer-readable storage medium 624 is shown in an exemplary embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present invention. The term “computer-readable storage medium” shall accordingly be taken to include, but not be limited to, solid-state memories, optical media, and magnetic media.

In the above description, numerous details are set forth. It will be apparent, however, to one of ordinary skill in the art having the benefit of this disclosure, that embodiments of the invention may be practiced without these specific details. In some instances, well-known structures and devices are shown in block diagram form, rather than in detail, in order to avoid obscuring the description.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying,” “transmitting,” “determining,” “computing,” “receiving,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Embodiments of the invention also relate to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The algorithms and displays presented herein are not inherently related to any particular computer or other apparatus. Various general purpose systems may be used with programs in accordance with the teachings herein, or it may prove convenient to construct a more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

The algorithms and displays presented herein are not inherently related to any particular computer or other apparatus. Various general purpose systems may be used with programs in accordance with the teachings herein, or it may prove convenient to construct a more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

It is to be understood that the above description is intended to be illustrative, and not restrictive. Many other embodiments will be apparent to those of skill in the art upon reading and understanding the above description. Moreover, the techniques described above could be applied to other types of data instead of, or in addition to, video clips (e.g., images, audio clips, textual documents, web pages, etc.). The scope of the invention should, therefore, be determined with reference to the appended claims, along with the full scope of equivalents to which such claims are entitled.

What is claimed is:

1. A method comprising:
determining, by a computer system, that a repository stores at least N video clips whose timestamps are within a time threshold of each other and whose geolocation stamps are within a distance threshold of each other, wherein N is an integer greater than one;
inferring by the computer system, based on the existence of the at least N video clips, that an event of interest occurred at a time and geolocation indicated by the at least N video clips; and
generating a notification signal that indicates that an event of interest likely occurred at the time and geolocation indicated by the at least N video clips.

2. The method of claim 1 wherein the notification signal is transmitted to a law enforcement agency.

3. The method of claim 1 wherein at least one of the at least N video clips is recorded, geolocation-stamped, and uploaded by a wireless terminal.

4. The method of claim 1 further comprising determining a value for N.

5. The method of claim 4 wherein the determination of a value for N is based, at least in part, on the time indicated by the at least N video clips.

6. The method of claim 4 wherein the determination of a value for N is based, at least in part, on the geolocation indicated by the at least N video clips.

7. The method of claim 1 wherein one or both of the time threshold and the distance threshold are based on at least one of:
the time indicated by the at least N video clips, and
the geolocation indicated by the at least N video clips.

8. The method of claim 1 wherein one or both of the time threshold and the distance threshold are based on the value of N.

9. An apparatus comprising:
a network interface device; and
a processor to:
receive, via the network interface device, a signal that indicates that a video clip has been uploaded to a repository,
determine that the repository stores at least N other video clips whose timestamps are within a time threshold of the video clip and whose geolocation stamps are within a distance threshold of the video clip, wherein N is a positive integer,
infer, based on the existence of the video clip and the at least N other video clips, that an event of interest occurred at a time and geolocation indicated by the video clip, and
generate a notification signal that indicates that an event of interest likely occurred at the time and geolocation indicated by the video clip.

10. The apparatus of claim 9 wherein the notification signal is transmitted to a news organization.

11. The apparatus of claim 9 wherein at least one of the at least N video clips is recorded, geolocation-stamped, and uploaded by a wireless terminal.

12. The apparatus of claim 9 further comprising determining a value for N.

13. The apparatus of claim 12 wherein the determination of a value for N is based, at least in part, on the time indicated by the at least N video clips.

14. The apparatus of claim 12 wherein the determination of a value for N is based, at least in part, on the geolocation indicated by the at least N video clips.

15. The apparatus of claim 12 wherein one or both of the time threshold and the distance threshold are based on at least one of:
the time indicated by the at least N video clips, and
the geolocation indicated by the at least N video clips.

16. The apparatus of claim 12 wherein one or both of the time threshold and the distance threshold are based on the value of N.

17. A non-transitory computer-readable storage medium, having instructions stored therein, which when executed, cause a computer system to perform a method comprising:
determining, by the computer system, that a repository stores at least N video clips whose timestamps are within a time threshold of each other and whose geolocation stamps are within a distance threshold of each other, wherein N is an integer greater than one;
inferring by the computer system, based on the existence of the at least N video clips, that an event of interest occurred at a time and geolocation indicated by the at least N video clips; and
generating a notification signal that indicates that an event of interest likely occurred at the time and geolocation indicated by the at least N video clips.

18. The non-transitory computer-readable storage medium of claim 17 wherein the method further comprises determining a value for N.

19. The non-transitory computer-readable storage medium of claim 18 wherein the determination of a value for N is based, at least in part, on the time indicated by the at least N video clips.

20. The non-transitory computer-readable storage medium of claim 18 wherein the determination of a value for N is based, at least in part, on the geolocation indicated by the at least N video clips.
